(19) United States
(12) Patent Application Publication
(10) Pub. No.: US 2024/0406130 A1
(43) Pub. Date: Dec. 5, 2024

(54) Method and system for saving and reposting selected chat messages

(71) Applicants: Meir Dahan, Tveria (IL); Eliahu Antopolsky, Zichron Yaakov (IL)

(72) Inventors: Meir Dahan, Tveria (IL); Eliahu Antopolsky, Zichron Yaakov (IL)

(21) Appl. No.: 18/375,553

(22) Filed: Oct. 2, 2023

Related U.S. Application Data
(63) Continuation-in-part of application No. 18/205,566, filed on Jun. 5, 2023, now abandoned.

(51) Int. Cl. H04L 51/216; H04L 51/52

(52) U.S. Cl. CPC H04L 51/216; H04L 51/52

(57) ABSTRACT

A system and method for saving and one-sided reposting selected messages from a chat of a communication application that includes the steps of displaying a save for future repost button on the computing device of the user, applying a save for future repost mode on the selected messages that save them on a memory, displaying a repost button on the computing device of the user, executing a repost command by using the repost button on the computing device of the user that causes the saved selected messages to be received and reposted on the computing device of the user, and displaying a save prevention button on the computing device of the contact that is designed to disable the application of the save for future repost mode by the user.

### RELATED APPLICATIONS

This application is a continuation in part of U.S. patent application Ser. No. 18/205,566 filed on Jun. 5, 2023.

### TECHNICAL FIELD

The present invention refers to a system and a method for saving selected messages from the chat of a user and a contact of a communication application and for one-sided reposting the saved selected messages in the future.

### BACKGROUND ART

Many users of communication applications, that are instant messaging software applications, such as Messenger™, Snapchat™, WhatsApp™, Telegram™, iMessage™ and the like, send one to the other messages, such as text messages, voice messages, video messages, photos, videos, emojis, files (PDF, word and in other formats) and the like. Sometimes the user wants to save one or more selected messages from the messages in the chat of the user and the contact in communication application and to repost these saved messages on his computing device in the future. The present invention provides a solution for this need.

U.S. Pat. No. 11,362,978 of the inventors of the present invention discloses a method that by sending a digital re-posting command from both the computing devices of the user and of the contact to the server causes the server and the computing devices to repost the saved messages. However, the present invention is different and innovative, among other things, in that that the repost command is one-sided and made by the user only, without the need for the contact's cooperation, in that the one-sided repost has the option to be done on the user's computing device only, rather on both computing devices, and especially in that the method includes the save prevention button that enables each side to prevent the other side to the chat from performing the special save for the purpose of reposting.

Google chat provides an option to the user to send a reply to a specific incoming message that he received from the contact and by that to repost that incoming message again in the chat together with his reply. The present invention includes different steps and elements from Google Chat, and in general it is two different methods intended for different purposes. For example, the Google chat method does not save the selected message in a dedicated memory, and it is certainly not possible to repost after that incoming message after deletion from the chat, and these steps and elements are basic steps and elements of the present invention. In addition to that, Google chat does not have the step of displaying a save prevention button.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts schematically the computing devices of the user (31), the computing device of the contact (32) and the server (40), each one of them with a processing device (10).

FIG. 2 depicts schematically system (300).

### THE INVENTION

The main objective of the present invention is to provide a computer-implemented method for saving and one-sided reposting one or more selected messages (210) from messages (200) that are in a chat (220) of a user and a contact of a communication application that is performed by processing devices (10) running on a computing device of the user (31) and a computing device of the contact and possible also on a server (40). It is possible to implement the present invention on many kinds of messages, such as text messages, voice messages, video messages, photos, videos, emoji's, files and the like, and the term “messages” in this disclosure and in the claims refer to all these kinds of messages. The term “computing device” refers to any kind of smartphone, mobile device or a computer that is designed to have an internet connection. The term “processing device” refers to a processing device on a server or on the computing devices, or both.

The computer-implemented method includes the followings steps done by the following means:

Display by the computing devices of the user and the contact, the messages (200) in the chat (220) of the user and the contact in the communication application.

Display, by the computing device of the user, a save for future repost button (51) on a screen (310) of the computing device of the user (31) and possible also on a screen (320) of the computing device of the contact (32) for enabling the contact too to use the method as he wishes.

Apply, by using the save for future repost button on the screen of the computing device of the user, a save for future repost mode on the one or more selected messages (210) from the messages (200) that are in the chat.

Save, by the computing device of the user upon the application of the save for future repost mode, the selected message on a memory (500) used or controlled by the communication application. The saving action is configured to keep saving the selected message on said memory for future repost while the selected message is in the chat and also after deletion of the selected message from the chat. In other words, the save for future repost mode is designed to be applied by using the save for future repost button on the screen of the computing device of the user. The application of the save for future repost mode on the one or more selected messages is designed to cause the computing device of the user or the server to save the one or more selected messages on the memory.

The memory (500) can be a memory space in the computing device of the user or in the computing device of the contact that is used or controlled by the communication applications. This refers to the memory area of the computing device of the user or of the contact that the communication application takes over, so it is a kind of territory under its control, and the communication application can save the selected messages there, whatever will be done with them in the future depends on the application's software and features, and it is possible that the memory will be in the server of the communication application.

Display by the computing device of the user a repost button (52) on the screen of the computing device of the use.

Execute a repost command by using the repost button on the computing device of the user for receiving the saved selected message from said memory.

Repost, by the computing device of the user, on the screen of the computing device of the user said selected message received from said memory.

In another words and embodiment, send to the memory by the computing device of the user the repost command that is designed to be executed upon using the repost button on the screen of the computing device of the user only. The repost command is designed to cause the computing device of the user or the contact to send the selected messages that are stored on the memory, to receive by the computing device of the user from the memory the saved selected messages, upon sending the repost command and repost, by the computing device of the user, on the screen of the computing device of the user the received selected message.

It is possible that the computer-implemented method as described above will further include the steps of receiving the selected message stored on the memory also by the computing device of the contact (upon sending the repost command by the user) and not only to the computing device of the user, and also the step of reposting by the computing device of the contact on the screen of the computing device of the contact the received selected message. It is even preferably, that the method will provide the user the option to execute this one-sided repost command to cause the repost to be done on his device only or on both devices, when he wants to remind or prove something to the contact.

The computer-implemented method may further include the step of displaying, by the mobile devices of the user and the contact, a save prevention button (53) on the screen of the computing device of the user and on the screen of the computing device of the contact. The save prevention button on the screen of the computing device of the contact is designed to cause the server or the computing device of the user to disable the mobile device of the user to apply save for future repost modes on messages in said chat of the user and the contact (and the same is applies to the user). Means, that each side of a chat can enter the chat and select the option that disable the other side of saving messages from their chat for future one-sided repost. It is also possible, that when the contact select ‘disable’ as explained above, and the user tries to activate this option in the chat with that contact, then the method will display a notification that his contact disabled this option in their joint chat.

The present invention also discloses a computer system (300) for saving and one-sided reposting the one or more selected messages from the messages that are in the chat of the user and the contact of the communication application that comprises the processing devices running the computing devices of the user and the contact, and also possible on the server too. The computer system is configured to:

Display by the computing devices of the user and the contact the messages in their chat. Display by the computing device of the user (and possible of the contact too) the save for future repost button on the screen of the computing device of the user. As explained above, this button is designed to cause the mobile device of the user or the server to apply the save for future repost mode on the selected messages and the application of this mode is designed to cause the computing device of the user or the server to save these selected messages on the memory (500). Display by the mobile device of the user or the server the repost button on the screen of the computing device of the user that is designed to cause the mobile device of the user to execute the repost command. And, display by the mobile device of the contact the save prevention button on the screen of the computing device of the contact

The method of the present invention may be implemented in new or existing communication applications. The method enables the user of the communication application to save on the memory (500) important messages (text messages, voice messages, video messages, photos, videos, files, stickers, GIFs and emojis) that he thinks he may need to see or to show in future.

The buttons (51), (52) and (53) may be visible on the screens of the computing devices or may be invisible. Therefore the term “displaying” with regards to these buttons is illustrative. The use of these buttons may be done by tapping on or touching a graphic symbol on the screen of the computing devices, by tapping on or touching the screen of the computing devices in a certain way, by tilting the computing devices in a certain way, or in any other way that is commonly used to select an option or to execute an action on mobile devices with touch screens. The the term ‘displaying a button’ in this disclosure and in the claims means: providing the user with the option to execute the actions that these ‘buttons’ are designed to execute or perform, even though that the user's eye doesn't really see a button or anything on the screen. For example, placing three fingers on the screen and quickly sliding them down can cause some action on the device.

The method of the preset invention can be realized and performed through a feature that the operator of the communication application can add to it. The user can use this innovative feature by selecting one or more messages from the messages in the chat of the user and the contact in the communication application and to repost these saved selected messages on his computing device in the future whenever he wants.

The present invention meets a real and specific need, which is not answered by the patent mentioned in the introduction above. For example, a user can save a message he received from his lover in which she expresses her feelings, a user can save the address of a certain place (with which he corresponds in chat) and instead of scrolling back the chat box, he can simply make a one-sided repost and receive the saved message of the address, a lawyer can receive an important instruction from his client through a message (written, voiced, video message or in a file) (for example an instruction of a patent owner to his lawyer not to renew a registered patent), and the lawyer has an interest in keeping such messages in case of a dispute in the future; All these important messages should preferably be saved with or without the knowledge of the other party (the contact), and that they can be one-sided reposted at the decision of the user (the keeper) only, without the need for consent or action of the other party (the contact), and also, with the option of reposting the received message from the past on the keeper's device only (the user's computing device only).

It is also possible to save messages that are already in the box, and not only messages that arrive in the box after the feature is activated. The one-sided repost button may further configured to set time when the computing device of the user will send the one-sided repost command to the server or when the saved one or more selected messages will be sent from the server to the computing device of the user.

In one of the possibilities of applying the invention, the user can order that the saved messages be sent only to his device, or also to the device of the contact, and this is in the case, for example, when there is an argument about what was written between the user and the contact, and the contact is far away, so it is desirable that the contact receive the saved messages from the server to his device. This use can also constitute a kind of suggestive reminders, for example, a child sent a message to his parent that he will prepare lessons every evening, and in the event that on a particular evening the child does not sit down to prepare lessons, the parent can simply repost this saved message that will also reach the chat on the child's device, and he will understand the hint, or declaration of love that the partner saved and reposted after a long time to evoke sweet memories.

The selected messages are saved on the server; therefore, the possibility of losing the mobile phone (the computing device) does not create a fear of losing these saved messages. The saving of these messages is done separately from the possible standard saving of all the messages in the same communication application, because the standard saving can end at the decision of the operator of the communication application, the standard saving may disappear in case of changing the device and not downloading the history, on purpose or due to a mistake.

The fact that the saved messages come from the server of the company that operates the communication application gives these messages credibility in the event of a dispute (as opposed to a screenshot of the chat, for example, which can be manipulated), and the fact that the contact can also receive these saved message directly from the operator of the communication application gives credibility to messages that emerge from the distant past. Also, it is of course possible, and also desirable, that every message that arrives and is redisplayed on the device will bear the date and time it was originally sent, and an indication of who exactly sent each message to whom from among the saved messages coming from the server.

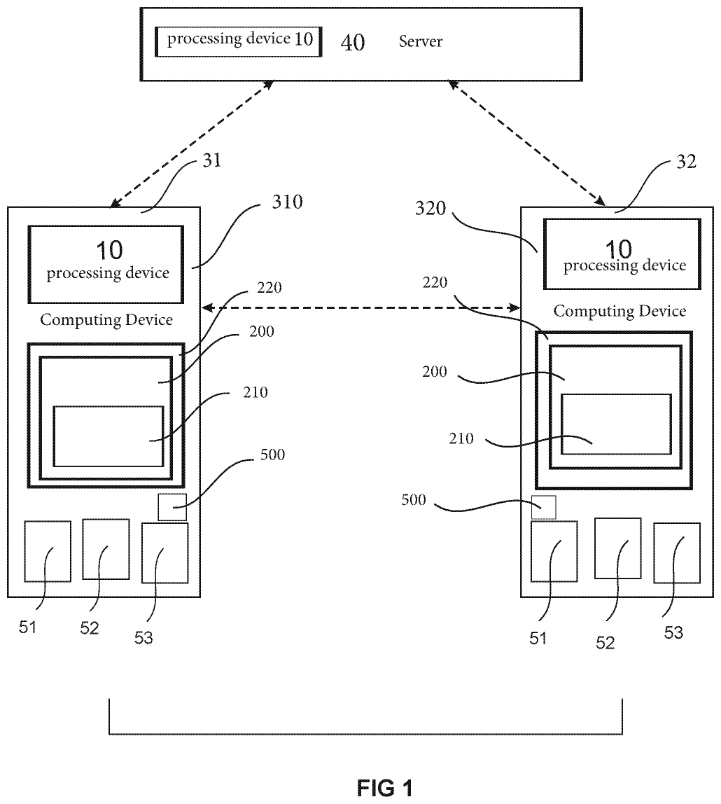

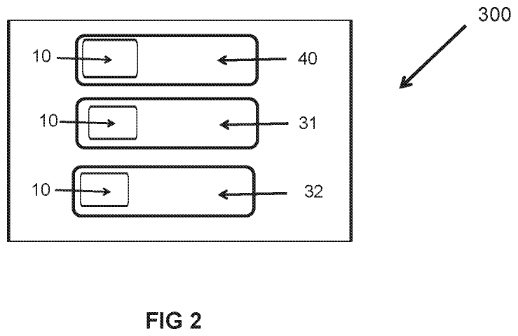

FIG. 1 depicts schematically the computing devices of the user (31), the computing device of the contact (32) and the server (40), each one of them with a processing device (10). FIG. 2 depicts schematically the system (300).

1: A computer-implemented method for saving and reposting a selected message from messages in a chat of a user and a contact of a communication application that is performed by processing devices running on a computing device of the user and a computing device of the contact, said computer-implemented method comprising:
displaying, by the computing devices of the user and the contact, the messages in the chat of the user and the contact in the communication application;
displaying, by the computing device of the user, a save for future repost button on a screen of the computing device of the user;
applying, by using the save for future repost button on the screen of the computing device of the user, a save for future repost mode on the selected message;
saving, by the computing device of the user upon the application of said save for future repost mode, the selected message on a memory on a server of the communication application, and wherein said saving action is configured to keep saving the selected message on said memory for future repost while the selected message is in the chat and after deletion of the selected message from the chat;
displaying, by the computing device of the user, a repost button on the screen of the computing device of the user;
executing a repost command by using the repost button on the computing device of the user for receiving said saved selected message from said memory, and
reposting, by the computing device of the user, on the screen of the computing device of the user said selected message received from said memory.

2: The computer-implemented method of claim 1 that further comprising:
displaying, by said mobile device of said contact, a save prevention button on a screen of the computing device of the contact, wherein the save prevention button on the screen of the computing device of the contact is designed to cause said computing device of said user to disable said application of said save for future repost mode on said selected message or on said messages in said chat.

3: The computer-implemented method of claim 1 that further comprising:
receiving from said memory, by said computing device of said contact, said selected message, upon said execution of said repost command; and
reposting, by the computing device of the contact, on a screen of the computing device of the contact said received selected message.

4: A computer-implemented method for saving and reposting a selected message from messages in a chat of a user and a contact of a communication application that is performed by processing devices running on a computing device of the user and a computing device of the contact, said computer-implemented method comprising:
displaying, by the computing devices of the user and the contact, the messages in the chat of the user and the contact in the communication application;
displaying, by the computing device of the user, a save for future repost button on a screen of the computing device of the user, wherein the save for future repost button on the screen of the computing device of the user is configured to apply a save for future repost mode on the selected message, and wherein the application of said save for future repost mode is configured to cause the computing device of the user to save the selected message on a memory on a server of the communication application; wherein said saving action is configured to keep saving the selected message on said memory for future repost while the selected message is in the chat and after deletion of the selected message from the chat;
displaying, by the computing device of the user, a repost button on the screen of the computing device of the user, wherein said repost button on the screen of the computing device of the user is designed to execute a repost command for receiving said saved selected message from said memory, and repost by the computing device of the user on the screen of the computing device of the user said selected message received from said memory;
displaying, by the mobile device of the contact, a save prevention button on a screen of the computing device of the contact, wherein the save prevention button on the screen of the computing device of the contact is designed to cause the computing device of the user to disable the application of the save for future repost mode on the selected message or on the messages in the chat.

5: A computer system for saving and reposting a selected message from messages in a chat of a user and a contact of a communication application comprising processing devices running on a computing device of the user and a computing device of the contact, said computer system is configured to:
display, by the computing devices of the user and the contact, the messages in the chat of the user and the contact in the communication application;
display, by the computing device of the user, a save for future repost button on a screen of the computing device of the user, wherein the save for future repost button on the screen of the computing device of the user is configured to apply a save for future repost mode on the selected message, and wherein the application of said save for future repost mode is configured to cause the computing device of the user to save the selected message on a memory on a server of the communication application; wherein said saving action is configured to keep saving the selected message on said memory for future repost while the selected message is in the chat and after deletion of the selected message from the chat;
display, by the computing device of the user, a repost button on the screen of the computing device of the user, wherein said repost button on the screen of the computing device of the user is designed to execute a repost command for receiving said saved selected message from said memory, and repost by the computing device of the user on the screen of the computing device of the user said selected message received from said memory;
display, by the mobile device of the contact, a save prevention button on a screen of the computing device of the contact, wherein the save prevention button on the screen of the computing device of the contact is designed to cause the computing device of the user to disable the application of the save for future repost mode on the selected message or on the messages in the chat.
